(19) United States
(12) Patent Application Publication
(10) Pub. No.: US 2013/0250559 A1
(43) Pub. Date: Sep. 26, 2013

(54) FABRIC INTEGRATED CONTINUOUS ILLUMINATION

(71) Applicant: EVERGREEN ENTERPRISES, INC., Richmond, VA (US)

(72) Inventor: Victor J. Hawkins, Castle Rock, CO (US)

(73) Assignee: EVERGREEN ENTERPRISES, INC., Richmond, VA (US)

(21) Appl. No.: 13/836,274

(22) Filed: Mar. 15, 2013

Related U.S. Application Data
(60) Provisional application No. 61/613,872, filed on Mar. 21, 2012.

(51) Int. Cl. F21V 33/00

(52) U.S. Cl. CPC F21V 33/008
USPC 362/183; 362/157; 362/253; 362/234

(57) ABSTRACT

A flag made of a flexible fabric is disclosed having a lighting feature incorporated therein. The lighting feature may take on various shapes and is configured to create a continuous illumination. The lighting feature may be removeably placed within a pocket on the flag or may be more permanently affixed to the surface of the flag or sandwiched between layers of material within the flag. The lighting feature may be powered by sources including batteries, solar power, and external power, and may be configured to automatically shut off when the ambient light level is high.

### CROSS-REFERENCE TO RELATED APPLICATION

This application claims the benefit of U.S. Provisional Application No. 61/613,872 filed Mar. 21, 2012, the contents of which is expressly incorporated herein by reference.

### BACKGROUND

Integrating lighted features into flexible fabric structures has been met with limited success. Typical implementations utilizing incandescent, LED, or other “point source” lights may suffer from poor reliability. More specifically, as the fabric is flexed, electrical connections between the point source lights are stressed and eventually broken. Further, such designs may create a safety hazard when the electrical connections are weakened or broken. More specifically, a loose or disconnected electrical power supply could ignite or burn adjacent objects or personnel and/or cause an uncomfortable or dangerous shock to an adjacent or nearby person.

Electroluminescent lighting (hereinafter “EL lighting”) utilizes an optical and electrical phenomenon in which a material emits light in response to the passage of an electric current or to a strong electric field to generate light from electricity. Advantages of EL lighting include durability, flexibility, and low power consumption.

### BRIEF DESCRIPTION OF THE DRAWINGS

FIG. 1 illustrates an example EL flag having a battery pack integrated in an upper-left corner of the EL flag.

FIG. 2 illustrates an example EL flag having a battery pack integrated in a lower-left corner of the EL flag.

FIG. 3 illustrates an example EL flag having a battery pack integrated with a flagpole associated with the EL flag.

FIG. 4 illustrates an example EL flag having a solar panel and a light sensor attached to a flagpole associated with the EL flag.

FIG. 5 illustrates an example EL flag having a two-sided EL lighting feature.

FIG. 6 illustrates an example EL flag having a removable EL lighting feature.

FIG. 7 illustrates an example EL flag having a clear window that provides an unobstructed view of an EL lighting feature within the EL flag.

FIG. 8 illustrates an example EL flag having clear piping that provides an unobstructed view of an EL lighting feature that borders the EL flag.

FIG. 9 illustrates example operations for illuminating a fabric integrated continuous illumination lighting display.

### DETAILED DESCRIPTION

The presently disclosed technology utilizes EL lighting or other continuous illumination technologies integrated on or within a fabric material to illuminate the fabric material. While the following implementations are discussed with specificity to the design of flags, the concepts presented herein may also be applied to other fabric articles (e.g., clothing, shelters, containers, etc.). Further, while the following implementations are discussed specifically with regard to EL lighting, other continuous illumination technologies may also be used (e.g., chemiluminescense).

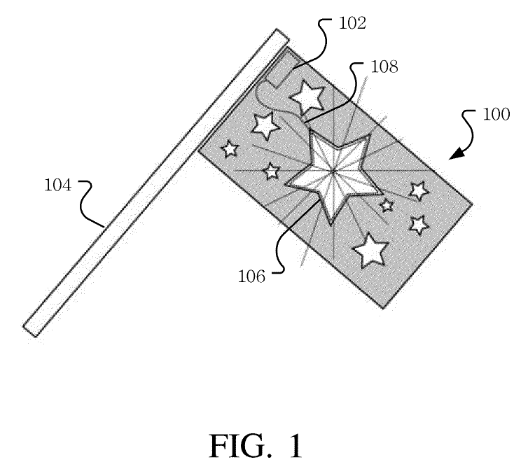

FIG. 1 illustrates an example EL flag 100 having a battery pack 102 integrated in an upper-left corner of the EL flag 100. The EL flag 100 may include a variety of designs, colors, and patterns intended to display an allegiance (e.g., the EL flag 100 may represent a specific country), a devotion (e.g., the EL flag 100 may represent a specific university or sports team), or merely present an attractive visual display. The EL flag 100 is attached to a flag pole 104 that may be used to secure the EL flag 100 to a variety of structures (e.g., a building, a vehicle) or the ground. In some implementations, the flag pole 104 is not included and the EL flag 100 is secured directly to a structure.

The EL flag 100 includes one or more EL lighting features (e.g., lighting feature 106) to provide a fabric integrated display. The EL lighting features present a continuous illumination, as distinct from discrete point source illumination (e.g., by incandescent or LED lights). The lighting feature 106 provides a uniformly lit star pattern. In one implementation, the lighting feature 106 is configured to blink or vary in its intensity over time to provide a desired visual effect. Further, the lighting feature 106 may possess a variety of colors and those colors may also change over time. Still further, other stars on the EL flag 100 may also be EL lighting features. In an implementation with multiple lighting features, each may be sequentially lit to provide an animated or otherwise visually engaging presentation.

In various implementations, the lighting feature 106 is laminated onto a surface of the EL flag 100, stitched into a similarly sized and shaped aperture in the EL flag 100, or placed within a similarly sized and shaped clear window in the EL flag 100. Other ways of integrating the lighting feature 106 into the EL flag 100 are contemplated herein.

The EL lighting features are fabricated using either organic or inorganic EL materials. The active EL materials are generally semiconductors having a wide enough bandwidth to allow the exit of the light from the EL material. An example EL material is inorganic thin-film EL (TFEL) (e.g., zinc sulfide topped with manganese, which has a yellow-orange emission). Other examples of the range of EL material include powdered zinc sulfide doped with copper (which produces a greenish light) or silver (which produces a bright blue light); thin-film zinc sulfide doped with manganese (which produces an orange-red color); naturally blue diamond, which includes a trace of boron that acts as a dopant; inorganic semiconductors containing group III and V elements, such as indium phosphate, gallium arsenide, and gallium nitride; and some organic semiconductors.

The lighting feature 106 is powered by the battery 102, which is located in the upper-left corner of the EL flag 100. The battery 102 may be single-use or rechargeable and incorporate a variety of technologies (e.g., zinc-carbon, alkaline, nickel-cadmium, nickel-zinc, nickel metal hydride, and lithium-ion). Further, the battery 102 may include two or more individual batteries linked in series or parallel to obtain a desired output voltage and/or capacity. In some implementations, no battery 102 is used and power for the lighting feature 106 is obtained from an external source (e.g., 110V household power).

The battery 102 is electrically connected to the lighting feature 106 by one or more electrical lines 108 (e.g., wires). In some implementations, the lighting feature 106 is directly connected to the battery 102 and no separate lines 108 are included. For example, a thin element of the lighting feature 106 may extend to the battery 102. The thin element of the lighting feature 106 may be blacked out so as not to detract from the visual display. In other implementations, the battery 102 is small enough that it may be incorporated immediately adjacent and electrically connected to the lighting feature 106 without significantly detracting from the visual display.

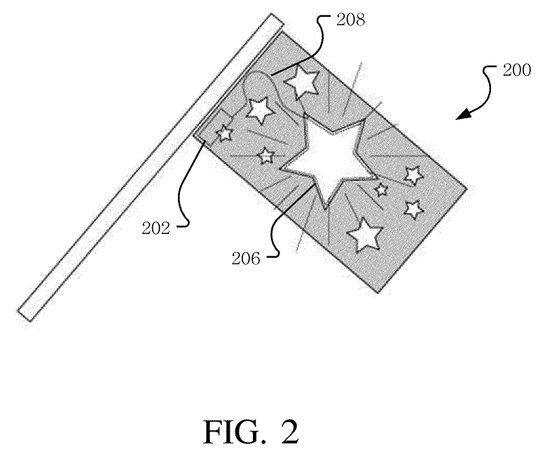

FIG. 2 illustrates an example EL flag 200 having a battery pack 202 integrated in a lower-left corner of the EL flag 200. The EL flag 200 may include a variety of designs, colors, and patterns intended to display an allegiance, a devotion, or merely present an attractive visual display. The EL flag 200 further includes one or more EL lighting features (e.g., lighting feature 206) to provide a fabric integrated display. The EL lighting features present a continuous illumination, as distinct from discrete point source illumination.

The lighting feature 206 is powered by the battery 202, which is located in the lower-left corner of the EL flag 200. In other implementations, the battery 202 may be located in other areas of the EL flag 200 or separate from the EL flag 200. The battery 202 may be single-use or rechargeable and incorporate a variety of technologies. Further, the battery 202 may include two or more individual batteries linked in series or parallel to obtain a desired output voltage and/or capacity. In some implementations, no battery 202 is used and power for the lighting feature 206 is obtained from an external source.

The battery 202 is electrically connected to the lighting feature 206 by one or more electrical lines 208. In some implementations, the lighting feature 206 is directly connected to the battery 202 and no separate lines 208 are included. For example, a thin element of the lighting feature 206 may extend to the battery 202. The thin element of the lighting feature 206 may be blacked out so as not to detract from the visual display. In other implementations, the battery 202 is small enough that it may be incorporated immediately adjacent and electrically connected to the lighting feature 206 without significantly detracting from the visual display.

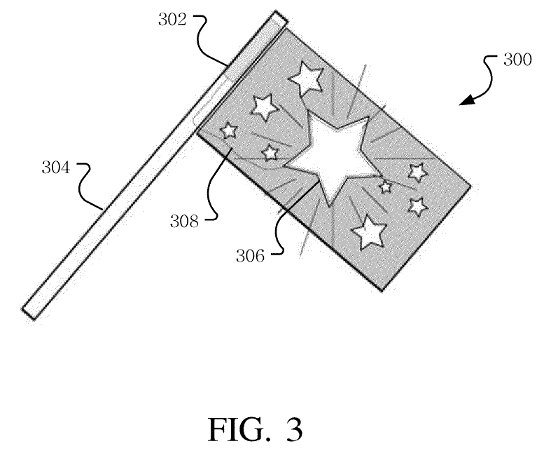

FIG. 3 illustrates an example EL flag 300 having a battery pack 302 integrated with a flagpole 304 associated with the EL flag 300. The EL flag 300 may include a variety of designs, colors, and patterns intended to display an allegiance, a devotion, or merely present an attractive visual display. The EL flag 300 is attached to the flag pole 304, which may be used to secure the EL flag 300 to a variety of structures or the ground. The EL flag 300 further includes one or more EL lighting features (e.g., lighting feature 306) to provide a fabric integrated display. The EL lighting features present a continuous illumination, as distinct from discrete point source illumination.

The lighting feature 306 is powered by the battery 302, which is located on or within the flag pole 304. In other implementations, the battery 302 may be located in other areas of the flag pole 304 or separate from the flag pole 304. The battery 302 may be single-use or rechargeable and incorporate a variety of technologies. Further, the battery 302 may include two or more individual batteries linked in series or parallel to obtain a desired output voltage and/or capacity. In some implementations, no battery 302 is used and power for the lighting feature 306 is obtained from an external source.

The battery 302 is electrically connected to the lighting feature 306 by one or more electrical lines 308. In some implementations, the lighting feature 306 is directly connected to the battery 302 and no separate lines 308 are included. For example, a thin element of the lighting feature 306 may extend to the battery 302. The thin element of the lighting feature 306 may be blacked out so as not to detract from the visual display. In other implementations, the battery 302 is small enough that it may be incorporated immediately adjacent and electrically connected to the lighting feature 306 without significantly detracting from the visual display.

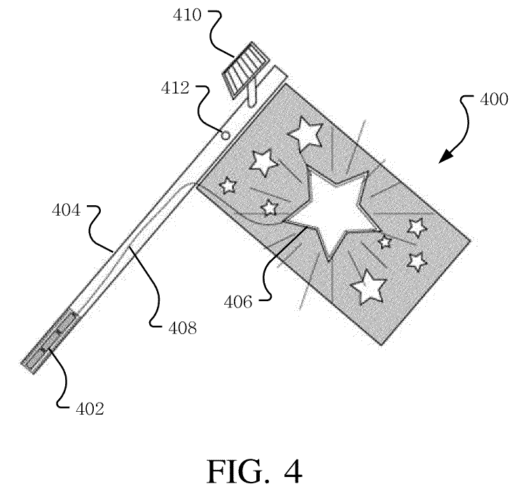

FIG. 4 illustrates an example EL flag 400 having a solar panel 410 and a light sensor 412 attached to a flagpole 404 associated with the EL flag 400. The EL flag 400 may include a variety of designs, colors, and patterns intended to display an allegiance, a devotion, or merely present an attractive visual display. The EL flag 400 is attached to the flag pole 404, which may be used to secure the EL flag 400 to a variety of structures or the ground. The EL flag 400 further includes one or more EL lighting features (e.g., lighting feature 406) to provide a fabric integrated display. The EL lighting features present a continuous illumination, as distinct from discrete point source illumination.

The lighting feature 406 is powered by the solar panel 410, which is a connected assembly of photovoltaic cells. The solar panel 410 may be a part of a larger photovoltaic system that includes the solar panel 410 and a battery 402, and electrical lines (e.g., lines 408) connecting the solar panel 410 and the battery 402 to the lighting feature 406. In operation, the solar panel 410 charges the battery 402 and the battery 402 provides power to the lighting feature 406. While sufficient solar energy to run the lighting feature 406 is available, the battery 402 remains charged. Once the available solar energy drops below the energy required to power the lighting feature 406, the battery 402 is depleted to power the lighting feature 406. If the available solar energy drops remains below the energy required to power the lighting feature 406, the battery 402 will eventually become entirely depleted and the lighting feature 406 will become unpowered until the battery 402 is recharged or replaced.

The light sensor 412 may turn the power to the lighting feature 406 on and off depending on the ambient lighting conditions. More specifically, when the ambient lighting level is low, the light sensor 412 may turn the lighting feature 406 on and when the ambient lighting level is high, the light sensor 412 may turn the lighting feature 406 off. The lighting feature 406 may not be particularly visible in high ambient lighting conditions and turning the lighting feature 406 off in such conditions may conserve power. In another implementation, the lighting feature 406 is turned on and off via a timer that is calibrated to illuminate the lighting feature 406 during nighttime and/or twilight hours. As used herein, the term “light sensor” may include a photovoltaic cell, a photoresistive element, or another light-sensitive element. The term “light sensor” may also include electronic circuitry programmed to detect when the light incident the solar panel 406 has dropped below a certain level, thereby using the solar panel 406 to detect light, rather than a separate light sensor 412. In such embodiments where the light sensor is in the form of electronic circuitry, the light sensor may be located on the flag pole 404 or elsewhere.

The solar panel 406 and the battery 402 are each located on or within the flag pole 404. In other implementations, the solar panel 406 and/or the battery 402 may be located in areas of the flag pole 404 other than that depicted or separate from the flag pole 404 altogether. The battery 402 may incorporate a variety of technologies and may include two or more individual cells linked in series or parallel to obtain a desired output voltage and/or capacity (e.g., three individual battery cells are shown linked in series in FIG. 4). In some implementations, no battery 402 is used and power for the lighting feature 406 is obtained directly from the solar panel 410.

The battery 402 and solar panel 406 are electrically connected to the lighting feature 406 by one or more electrical lines 408. In some implementations, the lighting feature 406 is directly connected to the battery 402 and/or the solar panel 406 and no separate lines 408 are included. For example, a thin element of the lighting feature 406 may extend to the battery 402 and/or the solar panel 406. The thin element of the lighting feature 406 may be blacked out so as not to detract from the visual display. In other implementations, the battery 402 and/or the solar panel 406 are small enough that they may be incorporated immediately adjacent and electrically connected to the lighting feature 406 without significantly detracting from the visual display.

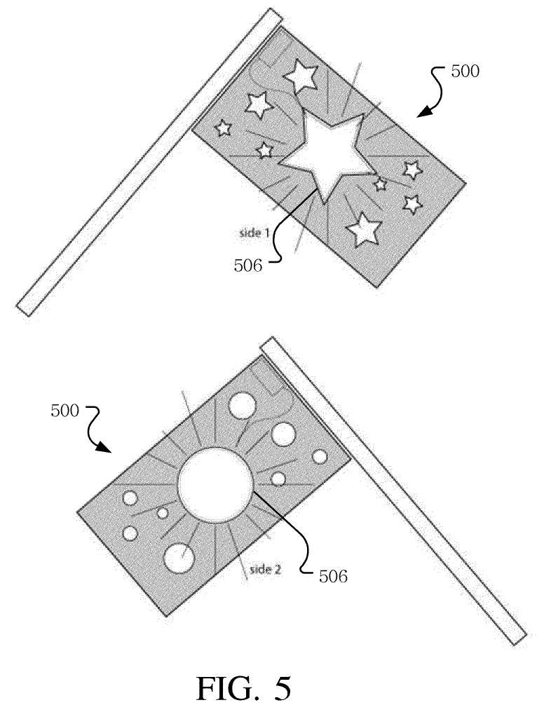

FIG. 5 illustrates an example EL flag 500 having a two-sided EL lighting feature 506. The EL flag 500 may include a variety of designs, colors, and patterns intended to display an allegiance, a devotion, or merely present an attractive visual display. The EL flag 500 further includes one or more EL lighting features (e.g., lighting features 506) to provide a fabric integrated display. The EL lighting features present a continuous illumination, as distinct from discrete point source illumination.

Side 1 of the EL flag 500 presents a star-shaped lighting feature and Side 2 of the EL flag 500 presents a circular lighting feature. The difference in appearance between the two sides may be accomplished by providing the lighting feature 506 that occupies the surface area of both the star-shaped and circular feature and using opaque flag material to form the visible shapes by selectively blocking light emitted from the lighting feature 506 on the two sides of the EL flag 500.

In one implementation, the lighting feature 506 is sandwiched between two layers of opaque flag material. In the area of the lighting feature 506 that is the star-shaped lighting feature on Side 1 and the circular lighting feature on Side 2, the flag material on each side of the lighting feature 506 is either transparent or is not present. In other implementations, there are at least two separate lighting features, one for each side of the EL flag 500, and there is an opaque layer between the separate lighting features that blocks light from one lighting feature from bleeding over to the other lighting feature.

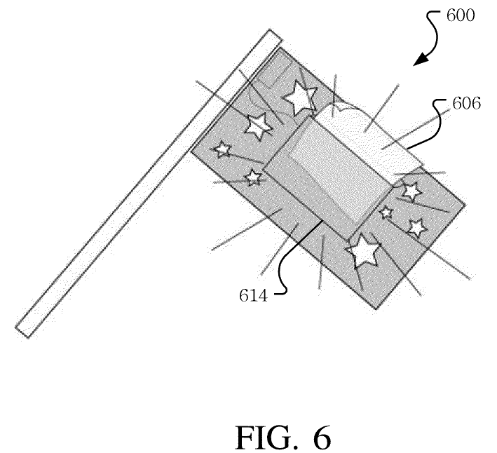

FIG. 6 illustrates an example EL flag 600 having a removable EL lighting feature 606. The EL flag 600 may include a variety of designs, colors, and patterns intended to display an allegiance, a devotion, or merely present an attractive visual display. The EL flag 600 further includes one or more EL lighting features (e.g., the lighting feature 606) to provide a fabric integrated display. The EL lighting features present a continuous illumination, as distinct from discrete point source illumination.

The EL flag 600 further includes a transparent or translucent sleeve 614 that accepts the lighting feature 606 in sheet form. This way, the lighting feature 606 may be easily changed out to present a different visual display. Further, the front, rear, or both sides of the sleeve 614 may be transparent or translucent so that the lighting feature 606 may be visible from the front, rear, or both sides of the EL flag 600. The sleeve 614 may be stitched, glued, attached with a hook-and-loop fastener, laminated, or otherwise permanently or removably attached to the EL flag 600.

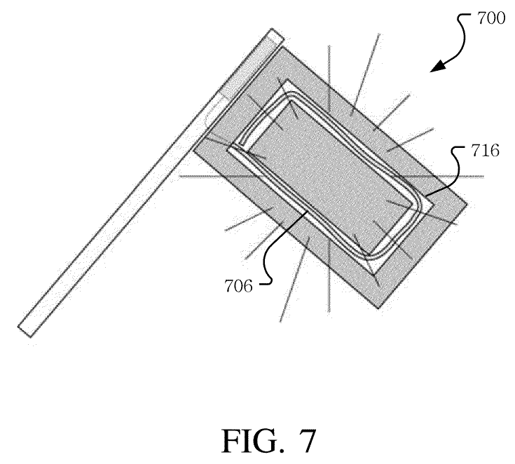

FIG. 7 illustrates an example EL flag 700 having a clear window 716 that provides an unobstructed view of an EL lighting feature 706 within the EL flag 700. The EL flag 700 may include a variety of designs, colors, and patterns intended to display an allegiance, a devotion, or merely present an attractive visual display. The EL flag 700 further includes one or more EL lighting features (e.g., the lighting feature 706) to provide a fabric integrated display. The EL lighting features present a continuous illumination, as distinct from discrete point source illumination.

The clear (or translucent) window 716 is depicted as a rectangular border in FIG. 7, but it may have any shape or size on the EL flag 700 to secure the EL lighting feature 706. Further, the window 714 may be on one or both sides of the EL flag 700, providing visibility to the EL lighting feature 706 on one or both sides of the EL flag 700. The lighting feature 706 in FIG. 7 is a rope or tubular shaped EL lighting feature (as opposed to the planar EL lighting features of FIGS. 1-6). In other implementations, multiple rope or tubular or planar shaped lighting features and corresponding windows may be used.

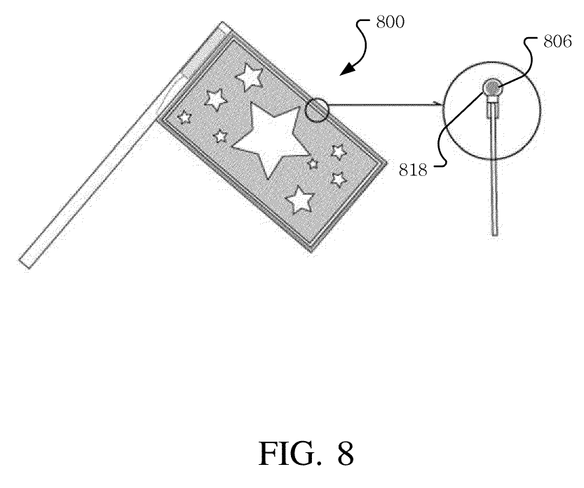

FIG. 8 illustrates an example EL flag 800 having clear piping 818 that provides an unobstructed view of an EL lighting feature 806 that borders the EL flag 800. The EL flag 800 may include a variety of designs, colors, and patterns intended to display an allegiance, a devotion, or merely present an attractive visual display. The EL flag 800 further includes one or more EL lighting features (e.g., lighting feature 806) to provide a fabric integrated display. The EL lighting features present a continuous illumination, as distinct from discrete point source illumination.

The clear (or translucent) piping 818 borders the entire EL flag 800 and the lighting feature 806 in rope form is contained within the piping 818. This form allows the lighting feature 806 to outline the EL flag 800. In other implementations, the clear piping 818 may have any shape or size on the EL flag 800 to secure the EL lighting feature 806 in a desired orientation. The piping 818 may be stitched, clipped, glued, attached with a hook-and-loop fastener, laminated, or otherwise permanently or removably attached to the EL flag 800.

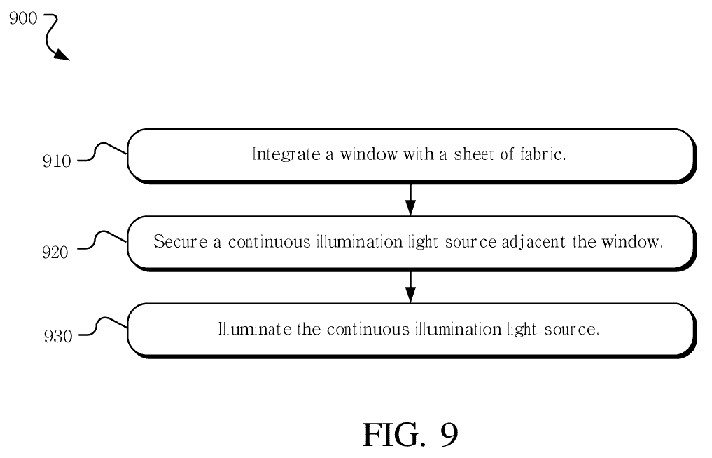

FIG. 9 illustrates example operations 900 for illuminating a fabric integrated continuous illumination lighting display. An integrating operation 910 integrates a window with a sheet of fabric. The integrating operation 910 may be permanent or removable and the window may take a variety of shapes and sizes consistent with an intended visual display. A securing operation 920 secures a continuous illumination light source adjacent the window. In one implementation, the window is stitched to the flag and the continuous illumination light source is placed adjacent the window and the window is closed around the continuous illumination light source (e.g., via more stitching) to hold the continuous illumination light source in place.

An illumination operation 930 illuminates the continuous illumination light source. The illumination operation 930 presents a desired visual display to individuals that view the fabric integrated continuous illumination lighting display (e.g., an illuminated flag). Further, the fabric integrated continuous illumination lighting display is robust due at least in part to the robust nature of the continuous illumination light source itself

The logical operations may be performed in any order and omitting or adding steps, unless explicitly claimed otherwise or a specific order is inherently necessitated by the claim language. The above specification, examples, and data provide a complete description of the structure and use of exemplary embodiments of the invention. Since many embodiments of the invention can be made without departing from the spirit and scope of the invention, the invention resides in the claims hereinafter appended. Furthermore, structural features of the different embodiments may be combined in yet another embodiment without departing from the recited claims.

As used herein, when referring to the battery or to how the lighting feature is powered by the battery, it will be understood by those having ordinary skill in the art that certain electronic circuitry may be necessary to accomplish certain features disclosed herein. This electronic circuitry is known to those having ordinary skill in the art and therefore is not disclosed with particularity herein. It will be understood that any such necessary electronic circuitry shall be electronically coupled to the necessary parts required for operation and may be located adjacent the battery, adjacent the lighting feature, or elsewhere. For example, it will be understood by those having ordinary skill in the art that the electronics necessary to convert the DC power from a battery into the AC power necessary to illuminate many electroluminescent materials may be incorporated into a case (i.e., battery pack) containing the battery and may be electronically coupled to both the battery and the lighting feature. Further, it will be understood by those having ordinary skill in the art that the term “battery” contemplates the use of any device capable of holding an electrical charge (e.g., chemical battery, fuel cell, capacitor, or others). It will be further understood by those having ordinary skill in the art that where the battery is a rechargeable battery, an external source (e.g., 110V household power) may be used to recharge the battery.

What is claimed is:

1. An article comprising:
a flag formed of fabric material;
a lighting feature secured adjacent to or within the fabric material that provides a continuous illumination; and
a power source that provides power to the lighting feature.

2. The article of claim 1, wherein the power source includes one or more of an external power source, a battery, or a rechargeable battery.

3. The article of claim 2, wherein the rechargeable battery is adapted to be recharged through an external power source

4. The article of claim 2, wherein the battery is integrated within the fabric structure.

5. The article of claim 1, wherein the power source is a rechargeable battery and further comprising a solar panel adapted to provide power to the rechargeable battery.

6. The article of claim 1, further comprising a light sensor adapted to turn off power from the power source to the lighting feature when ambient lighting level is high and to turn on power from the power source to the lighting feature when ambient lighting level is low.

7. The article of claim 1, further comprising a flag pole that supports the fabric material, wherein the power source is electrically connected to the lighting feature by electrical lines, and wherein at least one of the power source and the electrical lines is located at least partially within the flag pole.

8. The article of claim 1, wherein the flag includes a window and the lighting feature is positioned adjacent the window.

9. The article of claim 1, wherein:
the fabric material having a first side and a second side,
the lighting feature is visible from both the first side and the second side.

10. The article of claim 9, wherein:
the fabric material includes a first layer of opaque material adjacent the first side and a second layer of opaque material adjacent the second side,
each of the first layer of opaque material and the second layer of opaque material having at least one area of transparent material or no material, and
the lighting feature is sandwiched between the first layer of opaque material and the second layer of opaque material.

11. The article of claim 9, wherein the lighting feature is in a rope form and is secured to the fabric material by one of piping or a window.

12. The article of claim 1, wherein:
the fabric material has a first side and a second side,
the lighting feature is positioned adjacent to or within the first side, and
a second lighting feature is positioned adjacent to or within the second side.

13. The article of claim 1, wherein the fabric material includes a sleeve that removeably contains the lighting feature.

14. The article of claim 1, wherein the lighting feature provides continuous illumination by electroluminescence.

15. An article comprising:
a flag having a first side and a second side and being formed of a fabric material, and
a lighting feature configured to present a continuous illumination by chemiluminescense, the light feature being permanently or removeably secured adjacent to or within the fabric material.

16. The article of claim 15, wherein the lighting feature is visible from both the first side and the second side.

17. The article of claim 16, wherein
the fabric material includes a first layer of opaque material adjacent the first side and a second layer of opaque material adjacent the second side,
each of the first layer of opaque material and the second layer of opaque material having at least one area of transparent material or no material, and
the lighting feature is sandwiched between the first layer of opaque material and the second layer of opaque material.

18. The article of claim 15, wherein:
the fabric material has a first side and a second side,
the lighting feature is positioned adjacent to or within the first side of the fabric material, and
a second lighting feature configured to present a continuous illumination by chemiluminescense is positioned adjacent to or within the second side of the fabric material.

19. An illuminated flag, comprising:
a flag having a first side and a second side and including a sheet of fabric having an integrated window configured to allow light to pass through the window from the first side to the second side,
a lighting feature configured to present a continuous illumination comprising a piece of electroluminescent (EL) material and being secured in place within the window,
a battery pack configured to supply power to the electroluminescent material,
wherein the lighting feature is visible from both the first side and the second side.

20. The illuminated flag of claim 19, wherein the integrated window is of a similar size and shape as the lighting feature.
